(19) United States
(12) Patent Application Publication
(10) Pub. No.: US 2025/0004140 A1
(43) Pub. Date: Jan. 2, 2025

(54) GPS SATELLITE SIGNAL AUTHENTICATION BASED ON RELATIVE GAIN USING BEAMFORMING ANTENNA ELECTRONICS

(71) Applicant: BAE SYSTEMS Information and Electronic Systems Integration Inc., Nashua, NH (US)

(72) Inventor: John Jay Weger, Ely, IA (US)

(73) Assignee: BAE SYSTEMS Information and Electronic Systems Integration Inc., Nashua, NH (US)

(21) Appl. No.: 18/331,491

(22) Filed: Jun. 27, 2023

(51) Int. Cl. G01S 19/01; H01Q 3/34

(52) U.S. Cl. CPC G01S 19/015; H01Q 3/34

(57) ABSTRACT

Techniques for satellite signal authentication. In an example, a Global Positioning System (GPS) or global navigation satellite system (GNSS) includes antenna electronics, a processor, and a GPS or GNSS receiver. The antenna electronics is configured to provide, to the GPS or GNSS receiver, signals, wherein the signals comprise GPS or GNSS satellite signals received from a set of GPS or GNSS satellites and/or one or more falsified signals, such as spoofer signals (falsified). The processor is configured to determine, based on an expected location of a respective GPS or GNSS satellite of the set of GPS or GNSS satellites, an expected gain or expected power for a respective signal of the signals. The GPS or GNSS receiver is configured to measure a power of the respective signal, compare the measured power to the expected gain or expected power, and determine whether the respective signal is falsified based on the comparison.

### BACKGROUND

An important aspect of Global Positioning System (GPS) and global navigation satellite system (GNSS) technology is assurance of the accuracy and integrity of GPS and/or GNSS navigation data and timing. For example, assuring navigation data and timing in support of aerospace systems can be especially important in order to mitigate threats, such as adversarial spoofing or jamming signals. For instance, spoofed or falsified GPS or GNSS signals can imitate authentic signals, so as to confuse a GPS or GNSS system and users into misidentifying the source of a signal and/or mistaking a GPS or GNSS location. There is a need for techniques to detect spoofed signals and provide confidence that signals are authentic.

### SUMMARY

In an example, a Global Positioning System (GPS) or global navigation satellite system (GNSS) device comprising at least antenna electronics, a digital signal processor (DSP), and a GPS or GNSS receiver is provided. The antenna electronics can be configured to provide signals received from one or more sources to the GPS or GNSS receiver. In some cases, the signals may comprise one or more GPS or GNSS satellite signals, and the one or more sources may comprise a set of GPS or GNSS satellites. In some cases, the signals comprise one or more falsified signals, and the one or more sources may comprise one or more spoofer source (e.g., a satellite spoofer, an aircraft spoofer, a drone spoofer, a maritime spoofer, or a land based spoofer). Accordingly, in some cases, the GPS or GNSS receiver can be configured to determine whether the signals comprise a falsified signal or the one or more sources comprise a spoofer source, as disclosed herein. The DSP can be configured to determine, based on an expected location of a respective GPS or GNSS satellite of the set of GPS or GNSS satellites, an expected gain or expected power for a respective signal of the signals. In some cases, the DSP can also determine an antenna gain pattern as manipulated by the antenna electronics, and/or can determine the expected gain or expected power together with the antenna gain pattern. The GPS or GNSS receiver can be configured to receive the signals from the antenna electronics, and measure a power of the respective signal. The receiver can be further configured to compare the measured power to the expected gain or expected power, and determine whether the respective signal is falsified based on the comparison. For example, the receiver may determine the respective signal is authentic and likely originates from the respective GPS or GNSS satellite. Alternatively, the receiver may determine the respective signal is falsified and likely originates from a spoofer source (such as a satellite spoofer, an aircraft spoofer, a drone spoofer, a maritime spoofer, or a land based spoofer).

In another example, a Global Positioning System (GPS) or global navigation satellite system (GNSS) method is provided. The method can comprise providing, by antenna electronics and to a GPS or GNSS receiver, signals received from one or more sources. In some cases, the signals may comprise one or more GPS or GNSS satellite signals, and the one or more sources may comprise a set of GPS or GNSS satellites. In some cases, the signals comprise one or more falsified signals, and the one or more sources may comprise one or more spoofer source (e.g., a satellite spoofer, an aircraft spoofer, a drone spoofer, a maritime spoofer, or a land based spoofer). Accordingly, in some cases, the GPS or GNSS receiver can be configured to determine whether the signals comprise a falsified signal or the one or more sources comprise a spoofer source, as disclosed herein. The method can further comprise determining, by a digital signal processor (DSP) and based on an expected location of a respective GPS or GNSS satellite of the set of GPS or GNSS satellites, an expected gain or expected power for a respective signal of the signals. In some cases, the method can further comprise determining, by the DSP, an antenna gain pattern as manipulated by the antenna electronics, and/or determining the expected gain or expected power together with the antenna gain pattern. The method can further comprise measuring, by the GPS or GNSS receiver, a power of the respective signal. The method can further comprise comparing the expected gain or expected power to the measured power. The method can further comprise determining whether the respective signal is falsified based on the comparison. For example, the method may determine the respective signal is authentic and likely originates from the respective GPS or GNSS satellite. Alternatively, the method may determine the respective signal is falsified and likely originates from a spoofer source (such as a satellite spoofer, an aircraft spoofer, a drone spoofer, a maritime spoofer, or a land based spoofer).

In another example, a system is provided. The system can comprise a Global Positioning System (GPS) or global navigation satellite system (GNSS) antenna array, a GPS or GNSS digital signal processor (DSP), and a GPS or GNSS receiver. The antenna array can be configured to receive signals from one or more sources. In some cases, the signals may comprise one or more GPS or GNSS satellite signals, and the one or more sources may comprise a set of GPS or GNSS satellites. The antenna array can be further configured to provide the signals comprising the GPS or GNSS satellite signals to the GPS or GNSS receiver. In some cases, the signals comprise one or more falsified signals, and the one or more sources may comprise one or more spoofer source (e.g., a satellite spoofer, an aircraft spoofer, a drone spoofer, a maritime spoofer, or a land based spoofer). Accordingly, in some cases, the GPS or GNSS receiver can be configured to determine whether the signals comprise a falsified signal or the one or more sources comprise a spoofer source, as disclosed herein. The GPS or GNSS DSP can be configured to determine, based on an expected location of a respective GPS or GNSS satellite of the set of GPS or GNSS satellites, an expected gain or expected power for a respective signal of the signals. In some cases, the GPS or GNSS DSP can also determine an antenna gain pattern as manipulated by the antenna electronics, and/or can determine the expected gain or expected power together with the antenna gain pattern. The GPS or GNSS receiver can be configured to measure a power of the respective signal. The receiver can be further configured to compare the expected gain or expected power to the measured power. The receiver can be further configured to determine whether the respective signal is falsified based on the comparison. For example, the receiver may determine the respective signal is authentic and likely originates from the respective GPS or GNSS satellite, or alternatively, that the respective signal is falsified and likely originates from a spoofer source (such as a satellite spoofer, an aircraft spoofer, a drone spoofer, a maritime spoofer, or a land based spoofer).

### BRIEF DESCRIPTION OF THE DRAWINGS

FIG. 1 is a block diagram illustrating a Global Positioning System (GPS), configured to perform GPS satellite signal authentication based on relative gain using beamforming antenna electronics, in accordance with an example of the present disclosure.

FIG. 2 schematically illustrates an example of a geolocated apparatus, such as an aircraft, comparing observed to expected signal gains for a constellation of GPS satellites, in accordance with an example of the present disclosure.

FIG. 3 illustrates example antenna patterns for eight L1-frequency beams provided by the directional antenna array during beamforming GPS operation, in accordance with an example of the present disclosure.

FIG. 4 is a block diagram illustrating a system for generating a covariance matrix specifying spatial cross-correlations of antenna elements, which can be used to generate weights and determine expected gains in the GPS of FIG. 1, in accordance with an example of the present disclosure.

FIG. 5 is a flow diagram illustrating a method to authenticate GPS signals, in accordance with an example of the present disclosure.

FIG. 6 is a flow diagram illustrating a GPS method for generating weights that can be used to determine expected gains, based on a covariance matrix, when authenticating GPS signals in accordance with an example of the present disclosure.

### DETAILED DESCRIPTION

Techniques are disclosed for Global Positioning System (GPS) satellite signal authentication. An example method includes providing, by antenna electronics, signals received from one or more sources. In some cases, the signals may include one or more GPS or GNSS satellite signals, and the one or more sources may include a set of GPS or GNSS satellites. In some cases, the GPS or GNSS receiver can determine whether the one or more sources comprise a spoofer source (e.g., a satellite spoofer, an aircraft spoofer, a drone spoofer, a maritime spoofer, or a land based spoofer), as disclosed herein. The method can further comprise determining, by a digital signal processor (DSP) and based on an expected location of a respective GPS or GNSS satellite of the set of GPS or GNSS satellites, an expected gain or expected power for the respective signal that is unique to each individual pattern generated within the antenna controller (e.g. each ‘beam’). The method can further comprise measuring, by a GPS receiver, a power of the respective signal. The method can further comprise comparing the expected gain or expected power to the measured power, and determining whether the respective signal is falsified based on the comparison.

### General Overview

As described above, there is a need for authentication methods that can detect spoofed signals and provide confidence that signals are authentic. One possible approach to authenticate received signals is by testing the signal power. For instance, a signal may be identified as suspicious if it has signal power far greater or weaker than the nominally expected power from a respective satellite. Such an approach may rely on fixed reception pattern antennas, such as hemispherical antennas that have uniform gain from horizon to horizon. For a fixed reception pattern antenna, in effect the expected power may depend only on the distance to the respective satellite. However, such an approach is susceptible to spoofing, for example, by deliberately manipulating the spoofing signal strength so as to deceive the authentication system. Another possible approach might be to use a given digital GPS antenna controller and digital antenna electronics (DAE) to perform geometric verification of GPS signal authenticity. In particular, the advent of DAE has enabled array steering, which can generate individual antenna beams that direct gain towards respective satellites. For example, beam slewing across satellite location can be used to monitor gain fluctuation to authenticate the signals. However, such a geometric verification approach may experience degraded navigation performance during signal verification. Still another geometric authentication approach may involve intentional null steering, which may require additional beam and channel resources, as well as being sensitive to phase errors in the cabling, array, and signal processing chain. Preferably, each satellite in use for navigation would have a respective optimally steered beam from the antenna controller. However, when null-steering is utilized for authentication, one of the antenna beams must be diverted from a navigation function to be used for authentication instead.

Thus, techniques are described herein to provide GPS signal authentication and detection of spoofed signals. Because GPS receiver channel resources are cheaper than DAE beamforming resources, a digital GPS receiver may provide more satellite tracking channels than the DAE can supply with individual, optimized beams. In particular, in some embodiments, the techniques described herein can be used to exploit existing pattern disparities of multi-beam steering systems as a means of validating that a received signal is authentic. In some such embodiments, the techniques provide the advantage of maintaining all antenna beams in their primary function of optimal steering toward individual expected satellite locations, but take advantage of the diversity of satellite locations and the corresponding optimally steered patterns at different locations to validate that a respective signal is indeed received from the expected location of a respective satellite in the sky. In addition to using relatively few resources and maintaining beam resources for their primary purpose, some embodiments disclosed herein also may provide the advantage of not requiring rigorous calibration of the antenna elements or integration cabling. Accordingly, a system configured to perform the techniques can avoid the integration difficulties associated with other approaches and can facilitate access to accurate, secure Positioning, Navigation, and Timing (PNT) in a radio frequency (RF)-challenged environment. For example, the steering algorithm according to some such embodiments may be approximately 50 times more tolerant of phase error than some methods. Near multipath sources can also have lesser effect due to relatively high tolerance to phase error and its ability to integrate for long periods of user and satellite motion.

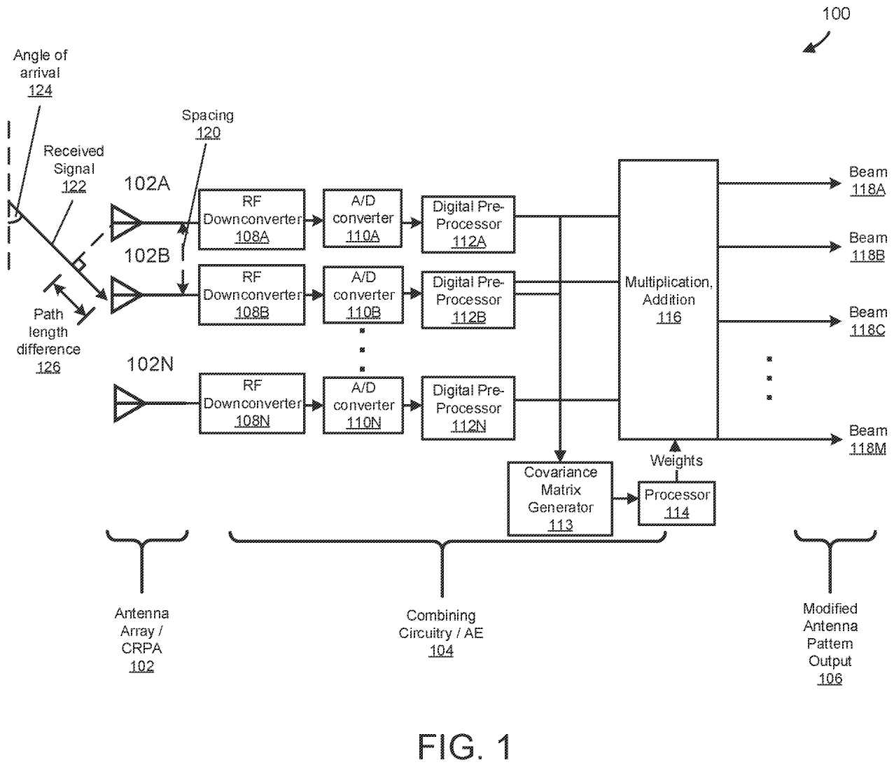

FIG. 1 is a block diagram of a Global Positioning System (GPS) 100 according to an example embodiment, which includes a directional antenna array 102 for beam steering and antenna electronics 104 for beamforming. In particular, such beam steering and beamforming functionality enables GPS 100 to utilize the multiple elements 102A-102N of antenna array 102 to shape a gain function of each resulting antenna beam, as described in this example. The GPS 100 can thereby direct beam gain to an expected location of each respective GPS satellite, while helping to cancel or “null” falsified or “jamming” signals originating from other locations. The beam disparities created by directional antenna array 102 and antenna electronics 104 can also be used to authenticate received GPS signals and detect falsified signals, as disclosed herein below.

In this example, the GPS 100 includes an antenna array and/or controlled radiation pattern antenna (CRPA) 102, which can include a number N of antenna elements 102A-102N. The combining circuitry and/or AE 104 includes N radiofrequency (RF) downconverters 108A-108N, N analog-to-digital (A/D) converters 110A-110N, and N digital preprocessors 112A-112N. The combining circuitry and/or AE 104 can combine the signals received by the individual elements 102A-102N into a modified antenna pattern output 106 comprising a number M of digital antenna beams 118A-118M. Ideally, M equals the number of satellites being tracked. In practice, M may depend only on the digital hardware, but the complexity of the digital beamformer 104 may increase with M, owing to the need for additional parallel hardware. In various examples, M may equal 12 to 16 beams, or any other number of beams.

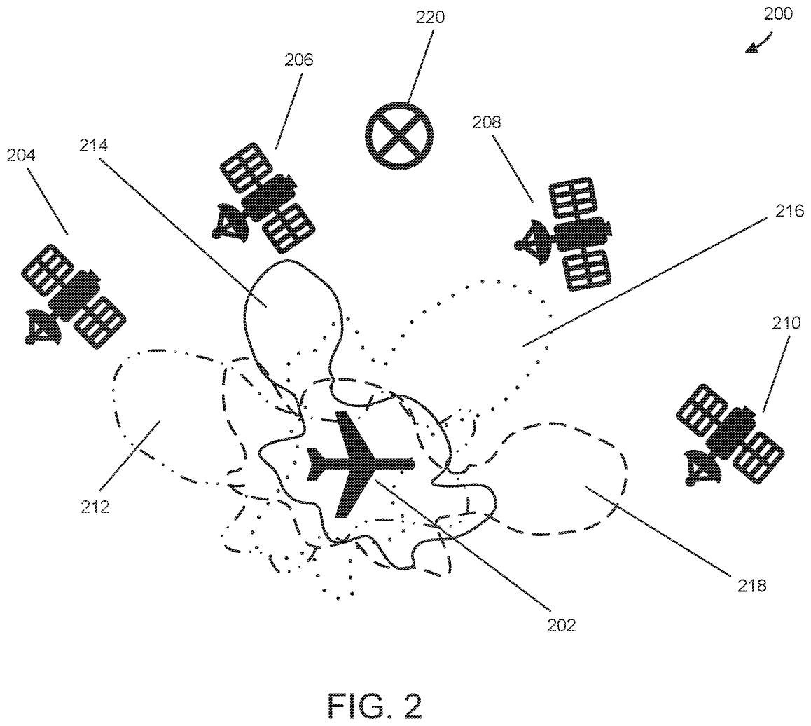

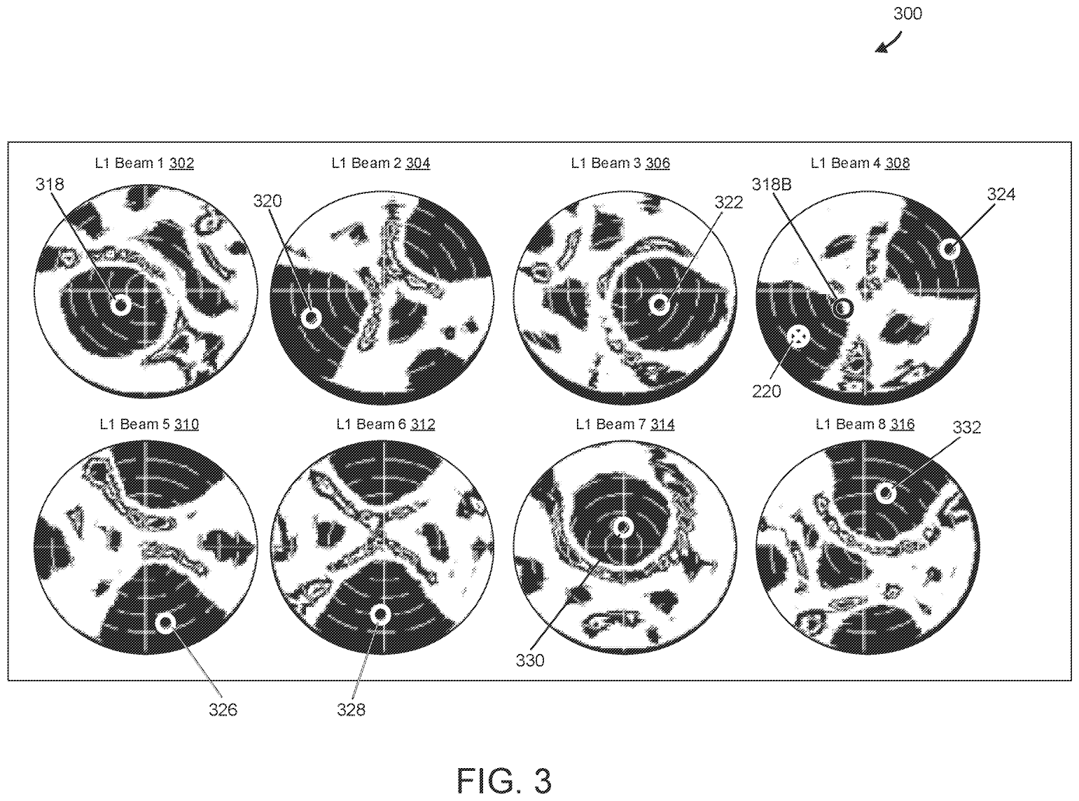

The antenna array 102 can include antenna elements 102A-102N, which may be spatially separated from each other. This spacing 120 can introduce time of arrival delays and phase differences 126 when the same signal 122 is detected by the respective antenna elements. The phase differences 126 can then be exploited by the electronics, for example the AE 104 can combine the received signals using weights, as described in this example. Accordingly, the AE 104 can produce beam patterns 118A-118N with regions of high gain and nulls, as illustrated in the examples of FIGS. 2-3. Such beam patterns can strengthen the signals received from the expected directions and/or locations of the tracked GPS satellites, while canceling or “nulling” possible jamming signals arriving from other directions.

For example, first consider a simplified case with N=2, such that array 102 shown in FIG. 1 contains antenna elements 102A and 102B. In this example, the output of element 102A may be transmitted directly to the summing network 116, while the output of element 102B can be multiplied by a weight W. In one very simple example, a single-frequency jamming signal 122 could arrive from the side of the array, with an angle of arrival 124 relative to the line of antenna elements 102A-102N of 0°. Since the elements 102A and 102B are separated by the spacing 120, there can be a delay in the time of arrival between these elements, corresponding to an optical path length difference 126, i.e. a difference in phase. For example, if the elements 102A and 102B are separated 120 by half a wavelength at the frequency being received (e.g., L1, L2, or some other frequency), the phase difference 126 can be 180°. In this simple case, setting W=1 can cause the received jamming signal 122 from neighboring elements 102A and 102B to sum together 180° out of phase, thereby nulling the jamming signal 122. Accordingly, the combination of antenna elements 102A and 102B with a weight W=1 can result in a first antenna beam with gain steered toward an angle of arrival of 90°, and with an angle of arrival of 0° nulled.

In another example, consider a jamming signal 122 arriving from an arbitrary angle 124. As a result of the path difference 126 to the two antenna elements, the signal at reference element 102A (e.g., with no multiplication by a weight) leads auxiliary element 102B (e.g., an element with a weight) by a phase θ_{B}. To cancel the jamming signal 122, the weight W should modify the phase of signal 122 by 180°−θ_{B}, thereby setting the output signal 180° out of phase with the reference signal. Again in this example, the jamming signal 122 can be nulled during summing.

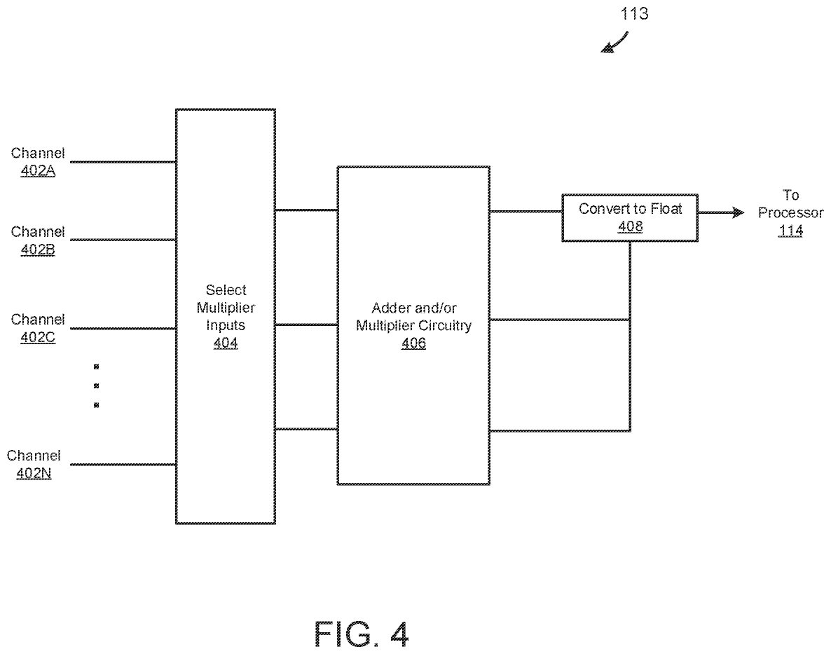

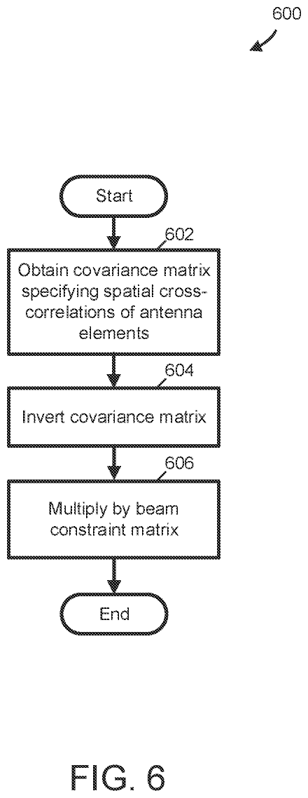

In a third example, consider a case where array 102 contains N antenna elements 102A-102N corresponding to N signal paths. In this case, there may be a total of N−1 adjustable weights. The weight W_{K} corresponding to the Kth auxiliary element 102K may modify the phase of signal 122 to (360°)(K−1)/N, so that signal 122 can be nulled. For example, if the Kth auxiliary element 102K has a phase difference of θ_{K}=K θ₁=K (360°) cos (φ) D/λ relative to element 102A, where D is the spacing 120, φ is the angle of arrival 124, and λ is the wavelength of the signal 122, then the weight W_{K} can modify the phase by an amount (360°)(K−1)/N−θₖ. In yet another example, the N−1 adjustable weights can provide sufficient degrees of freedom to null N−1 jamming signals at arbitrary angles of arrival simultaneously, as described below in the examples of FIGS. 4 and 6.

In this example, the combining circuitry and/or AE 104 utilizes respective RF downconverters 108A-108N after the respective antenna elements 102A-102N. The RF section 108A-108N may be critical to the anti-jamming or nulling performance of the GPS 100. In some examples, the receiver may provide one RF channel per antenna element, that is, one respective set of circuitry (such as circuitry 108A, 110A, and 112A) corresponding to each respective antenna element (such as antenna element 102A). Alternatively, the receiver may provide two RF channels per dual-frequency antenna element, to track both L1 and L2 frequencies. In yet another example, the receiver may provide over 100 channels.

The signals can then be routed to high resolution A/D converters 110A-110N, for example with 8-14 bits. The use of A/D converters with large numbers of bits (e.g., 14 or more bits) can improve the system's anti-jamming performance, but can also result in greater cost and power consumption. In addition, digital processing of high-resolution digital data requires more complex ASICs. Depending on the frequency plan used, digital preprocessors 112A-112N can convert the intermediate frequency signal to baseband (I & Q) signals and/or downsample (e.g., heterodyne) the signal to reduce the sample rate to the desired rate for processing.

Nulling can then simply involve multiplying each signal path by the appropriate weight and adding the paths together. Processor 114, for example a digital signal processor (DSP), can determine a set of weights based on an inverse of a covariance matrix and a beam constraint matrix, as described in greater detail below in the examples of FIGS. 4 and 6. The covariance matrix can specify spatial cross-correlations of the antenna elements 102A-102N, and can be generated by a covariance matrix generator 113. In an example, the beam constraint matrix can be chosen to specify that the dot product of the weights and a respective steering vector for a respective beam can be 1. Processor 114 can then use the determined weights to perform multiplication and addition for beamforming. Nulling may modify both the gain and phase of the signal.

As described above, even when gain is steered toward the expected locations of the GPS and/or GNSS satellites and away from other locations, spoofed or falsified signals can still imitate authentic signals, and confuse a GPS system or user into misidentifying the source of a signal and/or mistaking a GPS location. Accordingly, system 100 can be programmed or otherwise configured to detect spoofed signals and provide confidence that signals are authentic. For example, processor 114 can be programmed to carry out the methodology further described below with reference to FIGS. 2-6.

FIG. 2 schematically illustrates an example 200 of a geolocated apparatus 202, such as an aircraft, comparing observed to expected signal gains for a plurality of sources, such as a constellation of GPS satellites 204-210, in accordance with an example of the present disclosure.

In this example, the signals received by geolocated apparatus 202 from the sources (e.g., constellation of GPS satellites 204-210) may be beamformed into a plurality of antenna beams 212-218, using beam steering and/or beamforming techniques, such as those described in the example of FIG. 1. In particular, geolocated apparatus 202 may utilize a GPS device or system including a digital antenna controller and/or DAE that can perform such beamforming techniques, and a GPS receiver that receives and/or processes the signals on each beam to determine a GPS location.

Each respective antenna beam of beams 212-218 may be optimized for tracking a particular one of satellites 204-210 (also referred to as an on-beam channel). For example, the GPS receiver may command the DAE to steer each beam's gain in the direction of the respective on-beam satellite's expected location. The expected location may be based on location information received from the respective on-beam satellite, and/or based on the satellite's known orbit and timing information. In this example, as shown, beam 212 can have a maximum gain in the direction of arrival of signals from satellite 204, beam 214 can have a maximum gain in the direction of satellite 206, and so forth. Directions of arrival not corresponding to the tracked satellite (also referred to as off-beam channels) may be uncontrolled, for example the gain of beam 212 in the direction of satellite 206 and the gain of beam 214 in the direction of satellite 204 may be uncontrolled. This can result in an apparently random pattern of gain in the uncontrolled directions. However, such gains to non-steered satellites can be computed based on the antenna array and interference environment, as illustrated in the example of FIG. 3 below.

In some cases, “spoofed” or falsified GPS signals can imitate authentic signals, so as to confuse a GPS system or user into misidentifying a signal and/or mistaking a GPS location. For example, the signal spoofer 220 may seek to “jam” (i.e., interfere and/or replace) the signal from one or more of the authentic satellites 204-210. In various examples, the signal spoofer 220 could include a satellite spoofer, an aircraft spoofer, a drone spoofer, a maritime spoofer, and/or a land based spoofer.

Some embodiments described herein can detect such spoofed or counterfeit signals by tracking satellites 204-210 on all of antenna beams 212-218, including both the on- and off-beam channels. The system can then compare the tracked signal power to an expected gain or expected power for the expected satellite locations and signal patterns, as disclosed herein. The difference between calculated and observed gain can be used to determine if received signals are authentic, or conversely to detect “spoofed” or counterfeit signals. For example, if a respective signal (such as the signal from satellite 206 or from spoofer 220) does not have the predicted gain when tracked off-beam (for example, in beams 212, 214, or 218, or any combination thereof), then the system can determine that the respective signal is suspect. In particular, each satellite individually can have too complex an antenna gain pattern over the set of antenna beams to be successfully spoofed over the totality of the gain comparisons. Moreover, as described herein below, in some examples, the system can compare rapid changes in the expected and measured gain over time, making the authentic time-changing signal even more difficult to spoof.

In some examples, the GPS may ignore the satellite signals that are determined to be spoofed. For example, the GPS may discard the signal from spoofer 220 after determining it to be likely counterfeit, and may search for the genuine signal of the spoofed satellite, and/or may simply perform geolocation based on other authenticated signals. In some examples, the system may perform additional checks to verify signals flagged as suspect, for example, comparing the expected gain to the measured gain for those signals on additional beams.

In some examples, the system may determine whether the respective signal is authentic by continuing to track the signal over time and continuing to compare the expected and measured gain. For example, each satellite's location can change over time as it moves from horizon to horizon during the course of a 12 hour orbit. Likewise, the attitude of the geolocated apparatus 202, such as an aircraft, can change over time, for example the geolocated apparatus 202 may bank to turn, climb, or the like. The attitude of the geolocated apparatus 202, and the signals' angle of incidence on the antenna array, can have a large effect on the antenna pattern, and therefore on the gain comparison of on- or off-beam satellites. Accordingly, the system may confirm whether a respective signal is authentic by comparing the expected and measured gain in response to rapid changes in the expected location of the respective satellite, the attitude or orientation of the antenna array, and/or changes in the disparity in gain among satellites on each antenna beam.

Other applications of GPS receivers include drones, weapons and munitions that may utilize GPS signals for targeting and are prone to spoofing efforts. In a multimode system, if GPS spoofing is identified and not easily resolved, the item can use alternate methods of targeting such as electro-optical, infrared and/or imaging.

FIG. 3 illustrates example antenna patterns 300 for eight L1-frequency beams 302-316 provided by a DAE during beamforming GPS operation. In this example, beams 302-316 are in the L1 frequency, but in various examples, the disclosed system may be used with L1C, L2, L2C, L5, or any other frequency.

As described above in the examples of FIGS. 1-2, the GPS may apply beamforming techniques to direct gain toward the on-beam satellite of each respective antenna beam, thereby improving the on-beam satellite's tracking in jamming environments. Such beamforming techniques can optimize each respective beam for the expected location of a respective satellite. However, the overall beam shape and orientation may be uncontrolled, and may depend on the antenna array's geometry, orientation, and attitude (e.g., the attitude of an aircraft housing the antenna array). Accordingly the overall gain pattern and orientation may differ for the respective beams, as illustrated in this example.

In this example, the antenna patterns 302-316 illustrate the overall gain for eight L1-frequency beams provided by the DAE during beamforming. Each of polar plots 302-316 shows an antenna gain pattern for the upper hemisphere, with the dark shaded areas corresponding to the highest gain, and the light areas corresponding to the lowest gain (deepest nulls). Note that the number of spatial nulls in the resulting beam pattern depends only on the number of antenna elements. An N-element system can create N−1 spatial nulls per frequency.

In addition, the expected locations 318-332 of the on-beam satellites are illustrated within the gain patterns 302-316. In each of the beam plots 302-316, the expected locations 318-332 of the respective satellites correspond to the targets where the GPS receiver commands the DAE to steer gain.

In particular, the GPS may steer gain in the direction of the satellite's expected location, which may give rise to an apparently random gain pattern in other directions. In actuality, this gain pattern is not truly random, but is predictable and computable. Based on the weights being applied to the data, the DSP can compute this steering gain metric for each beam at any arbitrary sky location, for example by multiplying the output of each signal path in the DAE by the corresponding weight, as described herein. Furthermore, as described in greater detail in the examples of FIG. 2 above and FIGS. 4 and 6 below, the disclosed embodiments can compute the difference in gain between two locations on any given beam and/or between two beams at a given location.

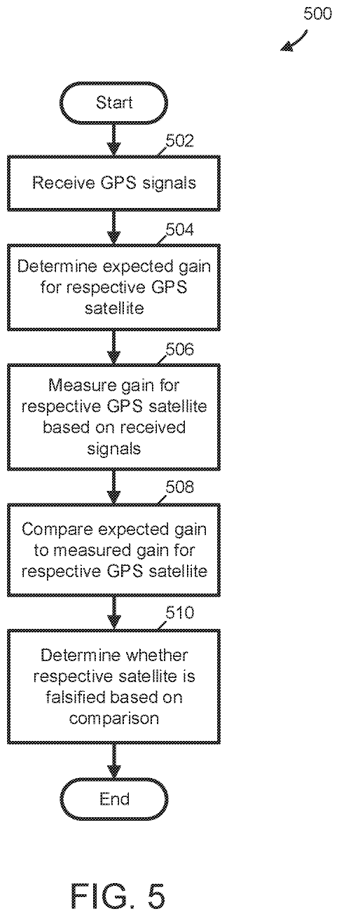

A digital GPS receiver may have nominally more satellite tracking channels (which are relatively inexpensive resources) than the DAE can supply with individual, optimized beams (which require relatively expensive resources). For example, the DAE may supply 16 digital beams, whereas the GPS receiver may have 32 satellite tracking channels (e.g., RF channels configured to follow the output of each antenna element). In another example, the receiver may provide over 100 satellite tracking channels. Accordingly, the disclosed system can use the receiver's satellite tracking channels to track many satellites on many beams, or all the satellites on all the beams. Note that, in some examples, tracking the satellites on multiple beams can require at least as many tracking channels as the product of the number of tracked satellites and the number of beams. In other examples, it is possible to sequence the satellites on channels not used to compute the navigation data. Note also that, while such digital beams and/or tracking channels are intended to track authentic GPS or GNSS satellites, in some cases, they may inadvertently track other signal sources, such as signal spoofers. Accordingly, as described in the examples of FIG. 2 above and FIG. 5 below, the disclosed system can use the tracked signals from the on- and off-beam satellites to compare the expected and observed gain, and can authenticate the received signals based on the comparison.

For example, the polar plot 308 for the fourth L1 beam shows the expected location of the on-beam satellite 324, which is in a region of high gain for the fourth L1 beam. In addition, polar plot 308 shows the location of off-beam satellite 318B, which corresponds to the on-beam satellite 318 of the polar plot 302 for the first L1 beam. In this example, the polar plot 308 shows that the off-beam satellite 318B is located in a region of low to moderate gain for the fourth L1 beam.

As described in the example of FIG. 1 above, the beam patterns 302-316 can result from the output of each signal path in the DAE being multiplied by a corresponding weight. The weights can be computed based on spatial cross-correlations of antenna elements and a beam constraint matrix, as described further in the examples of FIGS. 4 and 6 below. Accordingly, the system can determine the expected gain for each respective GPS satellite (such as on-beam satellite 318 and off-beam satellite 318B) by multiplying the expected signal at each antenna element from the expected location of the respective satellite by the corresponding weights.

The polar plot 308 also shows an example location of a signal spoofer 220, such as in the example of FIG. 2 above. In an example, the signal spoofer 220 may attempt to jam and/or falsify the signal from satellite 318B, but the disclosed system may be used to discover signal spoofer 220 by comparing the expected and observed gains. Although signal spoofer 220 is located relatively close to satellite 318B, signal spoofer 220 happens to be located in a region of high gain for the fourth L1 beam, whereas satellite 318B is located in a region of low to moderate gain. Accordingly, some embodiments described herein can recognize signal spoofer 220 as a likely spoofer due to its signal gain differing from the expected value for satellite 318B for the fourth L1 beam. In particular, because some embodiments described herein can track all of the satellites used for navigation on all the beams (e.g., tracking all of satellites 318-332 in all of beams 302-316 in this example), including off-beam satellites such as off-beam satellite 318B, they can discover spoofers such as signal spoofer 220 with high likelihood. Conversely, the disclosed embodiments can authenticate legitimate GPS satellite signals with high confidence.

Some embodiments described herein can be used to improve over some GPS systems by having reduced resource requirements, in particular only needing additional GPS tracking channels, which can be readily supplied by the GPS receiver more cheaply and abundantly than DAE beamforming resources. Ideally, each satellite being used for navigation has an optimally steered beam from the antenna controller. Although some methods may re-task one or more DAE outputs for authentication uses, some embodiments described herein can maintain all available antenna beams in their primary function of optimal steering toward individual satellites. In addition, the disclosed steering algorithm is very tolerant of phase error in the array, cabling, and installation environment (for example, approximately 50 times more tolerant than some methods). Accordingly, subtle measurement errors during installation and calibration have minimal effect on the gain disparity observed using the disclosed multi-beam tracking method, thereby avoiding the integration difficulties associated with some approaches and supporting easier access to accurate, secure PNT in an RF-challenged environment. Near multipath sources also have lesser effect due to the high tolerance to phase error and the ability to integrate for long periods of user and satellite motion.

FIG. 4 is a block diagram illustrating a system 113 for generating a covariance matrix specifying spatial cross-correlations of antenna elements, which can be used to generate weights and determine expected gains, in accordance with an example of the present disclosure. In some examples, system 113 may include one or more specialized circuits that can generate the covariance matrix, and may send the result to, or otherwise communicate with, a processor or DSP, such as processor or DSP 114 of the example of FIG. 1. Alternatively or additionally, system 113 may be integrated within a processor or DSP.

In this example, selector circuitry 404 may select among the incoming channels 402A-402N (e.g., the outputs of digital preprocessors 112A-112N of the example of FIG. 1) to provide inputs to adder and/or multiplier circuitry 406, which may include high-performance adders and/or multipliers. The adder and/or multiplier circuitry 406 can add and/or multiply its inputs, and can iterate as necessary, to determine the spatial cross-correlations of the antenna elements. In some examples, full precision may be maintained by representing the inputs and outputs of the adder and/or multiplier circuitry 406 as large signed integers. A respective completed covariance matrix element can be normalized (e.g., to an integer), converted 408 to a floating point representation, and sent to the processor or DSP 114 for weight calculation.

### Methodology

FIG. 5 is a flow diagram illustrating a method to authenticate GPS signals, in accordance with an example of the present disclosure. In various examples, method 500 may be performed by an antenna array, a digital antenna controller, a digital signal processor (DSP), and/or a receiver. For example, the antenna array, digital antenna controller, DSP, and/or receiver can belong to a GPS system, such as the GPS 100 of the example of FIG. 1.

As shown in FIG. 5, the GPS authentication method can start with the system receiving 502 signals from one or more sources. The received 502 signals can include one or more GPS or GNSS satellite signals, which may be received from a set of GPS or GNSS satellites included in the one or more sources. In some cases, the one or more sources may also include one or more spoofer sources, such as the signal spoofer 220 of the examples of FIGS. 2-3. For example, the spoofer source could be satellite-based (a satellite spoofer), aircraft-based (an aircraft spoofer), drone-based (a drone spoofer), vessel-based (a maritime spoofer, such as ship, submarine, buoy, or other water-based spoofer), and/or a land based spoofer (any land-based spoofing source). Accordingly, the method 500 can determine whether the sources include such a spoofer, as disclosed herein.

For example, the GPS system's antenna or antenna array and/or the digital antenna controller can receive 502 one or more directional signals, for example from respective GPS constellation satellites and/or from spoofers or other signal sources along particular lines of sight. For example, the antenna or antenna array may be steered toward particular directions or locations in the sky, and accordingly may receive stronger signals from particular directions. The received signal can be passed from the antenna or antenna array to digital antenna electronics (DAE) of a digital antenna controller. The DAE can beamform the signal, resulting in a plurality of antenna beams, with the respective beams optimized to receive signals from particular directions and/or locations, as in the examples of FIGS. 2-3 above. The DAE can supply the antenna beams, based on the received 502 directional signals, to a digital GPS or GNSS receiver.

In some examples, the digital GPS receiver may have more satellite tracking channels than the DAE can supply with individual, optimized beams. For example, the DAE may supply 16 digital beams, whereas the GPS receiver may have 32 satellite tracking channels. In another example, the receiver may provide over 100 satellite tracking channels. Preferably, each satellite in use for navigation would have an optimally steered beam from the antenna controller. Note that, while such digital beams and/or tracking channels are intended to track authentic GPS or GNSS satellites, in some cases, they may inadvertently track other signal sources, such as signal spoofers.

Next, the GPS authentication method can continue with the DSP determining 504 an expected gain or expected power for a respective signal of the received signals. The respective signal can correspond to a respective source among the signal sources, such as a respective GPS or GNSS satellite.

While the gain pattern for each beam is optimized for a given expected satellite location, the remainder of the pattern can be uncontrolled, as well as the antenna response for a non-steered signal source (e.g., a non-steered satellite) on a given beam. Based on the weights being applied to the data, the DSP can compute this steering gain metric for each beam at any arbitrary sky location. For example, the weights may be computed as an inverse of a covariance matrix, specifying spatial cross-correlations of antenna elements, multiplied by a beam constraint matrix. Computing 504 the weights and/or the expected gain at a given location for a given beam are described further in the examples of FIG. 4 above and 6 below. As described in the example of FIG. 1 above, the output of each signal path in the DAE can be multiplied by the corresponding weight. Therefore, determining 504 the expected gain or expected power for the respective GPS satellite can involve the DSP multiplying the expected signal at each antenna element from the expected location of the respective satellite by the corresponding weights. In some examples, the DSP also determines the antenna gain pattern as manipulated by the antenna electronics, and/or can determine 504 the expected gain or expected power together with the antenna gain pattern.

Table 1 shows an example of the computed expected gains (in dB) for each combination of expected satellite location and beam. In this example, beams 1 through N are optimized for the expected locations of satellites 1 through n, respectively. In practice, n may be less than N, because beamforming resources may be expensive or limited, but in this example the optimized satellites are shown on the diagonal of Table 1. By the same token, Table 1 also shows example values of gain for every combination of the satellites and the non-optimal beams.

TABLE 1

| | Sat- | Sat- | Sat- | Sat- | Sat- | Sat- | Sat- | Sat- |
|---|---|---|---|---|---|---|---|---|
| Beam | ellite | ellite | ellite | ellite | ellite | ellite | ellite | ellite |
| Number | 1 | 2 | 3 | 4 | 5 | 6 | 7 | n |
| 1 | +8 | −20 | 3 | −5 | −21 | −15 | −7 | 4 |
| 2 | 4 | +8 | −19 | 5 | 7 | −9 | 0 | −20 |
| 3 | −11 | 3 | +8 | 1 | 5 | −4 | −22 | 2 |
| 4 | 4 | −13 | −18 | +8 | −16 | −6 | −10 | −13 |
| 5 | 1 | −6 | −7 | 4 | +8 | −15 | −2 | −1 |
| 6 | −12 | −7 | −21 | −8 | −1 | +8 | 4 | −20 |
| 7 | −6 | −9 | −23 | −13 | −19 | −1 | +8 | −14 |
| N | −9 | −19 | −6 | −16 | −4 | −3 | −2 | +8 |

Accordingly, the DSP can compute gains for each combination of expected satellite location and beam, as in Table 1, and can send the GPS receiver a ranking of expected gains for each beam. Such a ranking can be unique based on the expected satellite locations and antenna array geometry, as in the examples of FIGS. 1-3.

Next, the GPS authentication method can continue with the receiver measuring 506 the gain for the respective signal of the received signals. For example, measuring 506 the gain may involve tracking the respective signal's source (e.g., a respective GPS satellite) on all the antenna beams. For example, tracking the respective signal source may include measuring a signal power at the expected location of a respective GPS satellite on the respective antenna beam and/or applying GPS code and carrier tracking methods to identify the respective GPS satellite. Accordingly, the gain measured 506 by the receiver may be based on the power measured for the respective signal source when tracked on the respective antenna beam. In some examples, the receiver may measure 506 the power for the respective signal when tracked on the respective antenna beam, and/or may determine (e.g., compute) the gain for the respective signal based on the measured power. The receiver can generate a ranking based on the power observed on each beam.

In some examples, the code and carrier phase from the channel tracking the optimal beam (i.e., the diagonal elements in Table 1; also referred to as on-beam channels) can be replicated in the channels tracking the non-optimal beams (corresponding to off-diagonal elements in Table 1; also referred to as off-beam channels). In some examples, by using the high power on-beam signal, the off-beam channels can observe very low-power or highly-attenuated signals.

Next, the GPS authentication method can continue with the receiver comparing 508 the expected gain to the measured gain. For example, the receiver can compare 508 the expected gain for the expected location of a respective GPS satellite to the measured gain for the respective signal.

Note that all of the beams can contain all of the signals, albeit at different gain values. For example, the off-beam power may be attenuated compared to the on-beam case. Accordingly, when comparing 508 the expected gain to the measured gain, the system may compute 504 the difference in gain at the same location on different beams, and may verify the computed gain difference based on the measured 506 signal power. Alternatively or additionally, the system may compute 504 the difference in gain between two locations on any given beam, and may verify this computed difference based on the measured 506 power.

In some examples, the receiver may compare 508 the measured 506 power to the expected gain, or to an expected power computed based on the weights and/or based on the expected gain. In some examples, the receiver may determine the measured gain for the respective signal based on a measured power, and may compare 508 the measured gain to the expected gain. The receiver can generate a ranking based on the power observed on each beam.

Next, the GPS authentication method can continue with the receiver determining 510 whether the respective signal and/or signal source is authentic based on the comparison.

For example, if a respective signal source (such as the satellite 318 in the example of FIG. 3) does not have the predicted power difference when tracked off-beam (e.g., in beam 308 of FIG. 3, or any combination of other beams) vs. on-beam (e.g., in beam 302 of FIG. 3), then the system can determine that the respective signal and/or signal source is suspect. In some examples, the GPS may ignore the signals and/or sources that are determined to be spoofed. For example, the GPS may discard the signals that are determined to be spoofed and may search for the genuine signal of the corresponding spoofed satellite, and/or may simply perform geolocation based on other authenticated signals. In some examples, the system may notify others in a relevant area of responsibility (AOR), for example an AOR associated with the spoofed satellite. In some examples, the system may perform additional checks to verify signals flagged as suspect, for example, comparing the expected gain to the measured gain for those signals on additional beams.

Alternatively or additionally, other applications of GPS receivers include drones, weapons and munitions that may utilize GPS signals for targeting and are prone to spoofing efforts. Accordingly, in a multimode system, if GPS spoofing is identified and not easily resolved, the item can use alternate methods of targeting such as electro-optical, infrared and/or imaging.

In some examples, the system may determine 510 whether the respective signal and/or signal source is authentic by continuing to track the signal over time and continuing to compare 508 the expected and measured gain. For example, each satellite's location can change over time as it moves from horizon to horizon during the course of a 12 hour orbit. Likewise, the attitude of the geolocated apparatus (e.g., geolocated apparatus 202 of FIG. 2, such as an aircraft) can change over time, for example the geolocated apparatus may bank to turn, climb, or the like. The attitude of the geolocated apparatus, and the signals' angle of incidence on the array, can have a large effect on the antenna pattern, and therefore on the gain comparison of on- or off-beam satellites. Accordingly, the system may confirm whether a respective signal is authentic by comparing 508 the expected and measured gain in response to changes in the expected location of the respective satellite, the attitude or orientation of the antenna array, and/or changes in the disparity in expected gain among the signals and/or signal sources on each antenna beam.

In another example, for GPS, with a 32 satellite constellation, between 8 and 12 satellites may typically be visible from any location on the Earth. For a reliable 3-dimensional geolocation, a minimum of 4 authentic GPS satellite signals are needed. Accordingly, in some examples, the system may receive more than the minimum number of satellite signals needed for geolocation. Such geometric redundancy can be used by the geolocated apparatus, for example an aircraft, to detect satellite faults and system faults.

The quality of the authentication 510 can depend on the disparity in the gain pattern for an optimally steered beam. Smaller arrays with small element spacing may generate wide beams, and may not provide the same level of pattern gain diversity as an array with half-wavelength spacing. In such cases, adding jamming signals and co-optimizing the beams for maximum signal-to-noise ratio may improve the algorithm by introducing deeper nulls and more geometric disparity into the pattern.

Some embodiments described herein provide several advantages over some geometric authentication methods. A first advantage is that the disclosed embodiments utilize relatively few resources. For example, some embodiments described herein may only use additional GPS tracking channel resources (e.g., RF channels configured to follow each antenna element), which can be readily provided by the GPS receiver more cheaply and abundantly than DAE beamforming resources. In particular, ideally each satellite used for navigation would have an optimally steered beam from the antenna controller, however some approaches occupy one of the antenna beams to perform null-steering for signal authentication purposes. By contrast, an embodiment of the present disclosure can maintain all the available antenna beams in their primary functions of optimal steering toward individual satellites, rather than re-tasking any of the DAE outputs for dedicated non-navigation uses, such as authentication. Accordingly, such an embodiment can address the challenges of GPS signal authentication and detection of spoofed signals, while providing the advantage of only using additional GPS tracking channels.

In addition, the steering algorithm is relatively more tolerant of phase error in the array, cabling, and installation environment (for example, approximately 50 times more tolerant than some approaches). Accordingly, subtle measurement errors during installation and calibration have minimal effect on the gain disparity observed using the disclosed multi-beam tracking method, thereby avoiding the integration difficulties associated with some approaches and supporting easier access to accurate, secure Positioning, Navigation and Timing (PNT) in an RF-challenged environment. Near multipath sources also have lesser effect due to the high tolerance to phase error and the ability to integrate for long periods of user and satellite motion.

The method 500 can then end.

FIG. 6 is a flow diagram illustrating a GPS method 600 for generating beamforming weights that can be used to determine expected gains, based on a covariance matrix, that can be used to determine expected gains, based on a covariance matrix, when authenticating GPS signals in accordance with an example of the present disclosure. In some examples, system 113 for generating a covariance matrix of FIG. 4 and method 600 for generating beamforming weights based on the covariance matrix can provide additional details of operation 504 of the method 500 of FIG. 5. In various examples, method 600 may be performed by a processor, a DSP, and/or a receiver. For example, the processor, DSP, and/or receiver can belong to a GPS system, such as the GPS 100 of the example of FIG. 1. In some examples, the method 600 may follow generating the covariance matrix, as illustrated in the example of FIG. 4. The weights can also be used for computing the expected gain at the expected location of an on- or off-beam satellite, or at any arbitrary location, as in the examples of FIGS. 3 and 5 and Table 1.

As shown in FIG. 6, generating beamforming weights based on a covariance matrix starts with the system obtaining 602 a covariance matrix specifying spatial cross-correlations of antenna elements. For example, the system can obtain 602 the covariance matrix from one or more circuits, such as the system 113 for generating the covariance matrix, as illustrated in the example of FIG. 4.

Next, the method of generating beamforming weights based on a covariance matrix continues with the system inverting 604 the covariance matrix. In various examples, the system may use any method of inverting 604 the covariance matrix, including but not limited to Gaussian elimination, iterative eigensolution, conversion to Jordan normal form, forward or back substitution (as described below), or any other method.

Next, the method of generating beamforming weights based on a covariance matrix continues with the system multiplying 606 the inverse of the covariance matrix by a beam constraint matrix. For example, the beam constraint matrix can be chosen to specify that the dot product of the weights and a respective steering vector for a respective beam should be 1. In some examples, minimizing the output power subject to this constraint can result in a maximum signal-to-noise ratio at the output.

In some examples, the system may combine the operations of inverting 604 the covariance matrix and multiplying 606 the inverse of the covariance matrix by a beam constraint matrix. For example, the system may use conversion to Jordan normal form and/or forward or back substitution to multiply 606 the inverse of the covariance matrix by the beam constraint matrix without explicitly computing the covariance matrix inverse. Alternatively, the system may explicitly invert 604 the covariance matrix, and then multiply 606 the inverse of the covariance matrix by the beam constraint matrix.

The method 600 can then end.

In some examples, the GPS system can include one or more non-transitory computer readable medium, which may include any suitable medium for storing digital information, such as a hard drive, a server, a flash memory, and/or random access memory (RAM), or a combination of memories. The one or more non-transitory computer readable medium may be read by one or more processors, such as processor 114 of the example of FIG. 1 above, which may execute code and/or instructions stored in a memory, such as instructions for any of the methods disclosed herein in the examples of FIGS. 5-6, and/or any other methods. In alternative embodiments, the components and/or modules disclosed herein can be implemented with hardware, including gate-level logic such as a field-programmable gate array (FPGA), or alternatively, a purpose-built semiconductor such as an application-specific integrated circuit (ASIC). In some embodiments, the hardware may be modeled or developed using hardware description languages such as, for example Verilog or VHDL. Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some examples may be implemented, for example, using a machine-readable medium or article which may store an instruction or a set of instructions that, if executed by a machine, may cause the machine to perform a method and/or operations in accordance with an embodiment provided herein. Such a machine may include, for example, any suitable processing platform, computing platform, computing device, processing device, computing system, processing system, computer, process, or the like, and may be implemented using any suitable combination of hardware and/or software. The machine-readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CD-RW) memory, optical disk, magnetic media, magneto-optical media, removable memory cards or disks, flash drives, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical quantities within the registers, memory units, or other such information storage transmission or displays of the computer system. The embodiments are not limited in this context.

The terms “circuit” or “circuitry,” as used in any embodiment herein, are functional structures that include hardware, or a combination of hardware and software, and may comprise, for example, singly or in any combination, hardwired circuitry, programmable circuitry such as computer processors comprising one or more individual instruction processing cores, state machine circuitry, and/or gate level logic. The circuitry may include a processor and/or controller programmed or otherwise configured to execute one or more instructions to perform one or more operations described herein. The instructions may be embodied as, for example, an application, software, firmware, or one or more embedded routines configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads or parallel processes in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), computers, and other processor-based or functional systems. Other embodiments may be implemented as software executed by a programmable device. In any such hardware cases that include executable software, the terms “circuit” or “circuitry” are intended to include a combination of software and hardware such as a programmable device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the example embodiments. It will be appreciated, however, that the embodiments may be practiced without these specific details. In other instances, well known operations, components and circuits have not been described in detail so as not to obscure the embodiments. It can be appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### ADDITIONAL EXAMPLES

Example 1 is a Global Positioning System (GPS) or global navigation satellite system (GNSS). The GPS or GNSS can comprise at least antenna electronics, a digital signal processor (DSP), and a GPS or GNSS receiver. The antenna electronics can be configured to provide signals to the GPS or GNSS receiver. The signals may comprise GPS or GNSS satellite signals received from a set of GPS or GNSS satellites, and/or one or more falsified signals. The DSP can be configured to determine, based on an expected location of a respective GPS or GNSS satellite of the set of GPS or GNSS satellites, an expected gain or expected power for a respective signal of the signals. The GPS or GNSS receiver can be configured to measure a power of the respective signal. The receiver can be further configured to compare the measured power to the expected gain or expected power. The receiver can be further configured to determine whether the respective signal is falsified based on the comparison.
Example 2 includes the GPS or GNSS of Example 1, wherein to provide the signals comprises to provide a set of antenna beams formed based on the signals. The expected gain or expected power for the respective signal can be based on an expected gain for a respective antenna beam of the set of antenna beams at the expected location of the respective GPS or GNSS satellite. The respective antenna beam can be steered to a respective steering location. The measured power for the respective signal can comprise a measured power of the respective signal while the respective signal is tracked on the respective antenna beam.
Example 3 includes the GPS or GNSS of Example 2, wherein the GPS or GNSS receiver is further configured to track the respective signal on the set of antenna beams.
Example 4 includes the GPS or GNSS of any one of Examples 2 through 3, wherein the GPS or GNSS receiver is further configured to rank the expected gain or expected power relative to a second expected gain or second expected power for a second antenna beam. The GPS or GNSS receiver can be further configured to rank the measured power relative to a second measured power for the second antenna beam. To compare the measured power to the expected gain or expected power can be based on the rankings.
Example 5 includes the GPS or GNSS of any one of the previous Examples, wherein to determine whether the respective signal is falsified based on the comparison can further comprise to determine whether the respective signal is falsified based on a change over time in one or more of: the expected location of the respective GPS or GNSS satellite, an attitude or orientation of a GPS or GNSS antenna array, or a disparity in expected gain among the signals on an antenna beam.
Example 6 includes the GPS or GNSS of any one of the previous Examples, wherein to determine the expected gain or expected power for the respective signal can be based on a set of weights.
Example 7 includes the GPS or GNSS of Example 6, wherein the GPS or GNSS device further comprises adder and/or multiplier circuitry configured to compute a covariance matrix specifying spatial cross-correlations of antenna elements. The set of weights can be based on an inverse of the covariance matrix and a beam constraint matrix.
Example 8 includes the GPS or GNSS of any one of the previous Examples, wherein the respective signal is authentic and originates from the respective GPS or GNSS satellite; or the respective signal is falsified and originates from one or more of a satellite spoofer, an aircraft spoofer, a drone spoofer, a maritime spoofer, or a land based spoofer.
Example 9 is a Global Positioning System (GPS) or global navigation satellite system (GNSS) method. The method can comprise providing, by antenna electronics and to a GPS or GNSS receiver, signals. The signals may comprise GPS or GNSS satellite signals received from a set of GPS or GNSS satellites, and/or one or more falsified signals. The method can further comprise determining, by a digital signal processor (DSP) and based on an expected location of a respective GPS or GNSS satellite of the set of GPS or GNSS satellites, an expected gain or expected power for a respective signal of the signals. The method can further comprise measuring, by the GPS or GNSS receiver, a power of the respective signal. The method can further comprise comparing the measured power to the expected gain or expected power. The method can further comprise determining whether the respective signal is falsified based on the comparison.
Example 10 includes the method of Example 9, wherein providing the signals comprises providing a set of antenna beams based on the signals. Determining the expected gain or expected power for the respective signal can comprise determining an expected gain or expected power for a respective antenna beam of the set of antenna beams at the expected location of the respective GPS or GNSS satellite. The respective antenna beam can be steered to a respective steering location. Measuring the power for the respective signal can comprise measuring the power for the respective signal while the respective signal is tracked on the respective antenna beam.
Example 11 includes the method of Example 10, further comprising tracking, by the GPS or GNSS receiver, the respective signal on the set of antenna beams.
Example 12 includes the method of any one of Examples 10 through 11, further comprising ranking the expected gain or expected power relative to a second expected gain or second expected power for a second antenna beam. The method can further comprise ranking the measured power relative to a second measured power for the second antenna beam. Comparing the measured power to the expected gain or expected power can be based on the rankings.
Example 13 includes the method of any one of Examples 9 through 12, wherein determining whether the respective signal is falsified based on the comparison further comprises determining whether the respective signal is falsified based on a change over time in one or more of: the expected location of the respective GPS or GNSS satellite, an attitude or orientation of a GPS or GNSS antenna array, or a disparity in expected gain among the signals on an antenna beam.
Example 14 includes the method of any one of Examples 9 through 13, wherein determining the expected gain or expected power for the respective signal is based on a set of weights.
Example 15 includes the method of Example 14, further comprising computing, by adder and/or multiplier circuitry, a covariance matrix specifying spatial cross-correlations of antenna elements. The set of weights can be based on an inverse of the covariance matrix and a beam constraint matrix.
Example 16 is a system. The system can comprise a Global Positioning System (GPS) or global navigation satellite system (GNSS) antenna array, antenna electronics, a GPS or GNSS digital signal processor (DSP), and a GPS or GNSS receiver. The antenna array can be configured to receive signals. The signals may comprise GPS or GNSS satellite signals received from a set of GPS or GNSS satellites, and/or one or more falsified signals. The antenna electronics can be configured to provide signals comprising the GPS or GNSS satellite signals to a GPS or GNSS receiver. The GPS or GNSS DSP can be configured to determine, based on an expected location of a respective GPS or GNSS satellite of the set of GPS or GNSS satellites, an expected gain or expected power for a respective signal of the signals. The GPS or GNSS receiver can be configured to measure a power of the respective signal. The receiver can be further configured to compare the expected gain or expected power to the measured power. The receiver can be further configured to determine whether the respective signal is falsified based on the comparison.
Example 17 includes the system of Example 16, wherein to provide the signals to the receiver further comprises to form a set of antenna beams based on the signals received by the antenna array. The expected gain or expected power for the respective signal can be based on an expected gain for a respective antenna beam of the set of antenna beams at the expected location of the respective GPS or GNSS satellite. The antenna electronics can be further configured to steer the respective antenna beam to a respective steering location. The measured power of the respective signal can comprise a measured power of the respective signal while the respective signal is tracked on the respective antenna beam.
Example 18 includes the system of Example 17, wherein the GPS or GNSS receiver is further configured to rank the expected gain or expected power relative to a second expected gain or second expected power for a second antenna beam. The GPS or GNSS receiver can be further configured to rank the measured power relative to a second measured power for the second antenna beam. To compare the measured power to the expected gain or expected power can be based on the rankings.
Example 19 includes the system of any one of Examples 16 through 18, wherein to determine whether the respective signal is falsified based on the comparison comprises to determine whether the respective signal is falsified based on a change over time in one or more of: the expected location of the respective GPS or GNSS satellite, an attitude or orientation of the GPS or GNSS antenna array, or a disparity in expected gain among the signals on an antenna beam.
Example 20 includes the system of any one of Examples 16 through 19, wherein to determine the expected gain or expected power for the respective signal is based on a set of weights.
Example 21 includes the system of Example 20, further comprises adder and/or multiplier circuitry configured to compute a covariance matrix specifying spatial cross-correlations of antenna elements. The set of weights can be based on an inverse of the covariance matrix and a beam constraint matrix.

The foregoing description of the embodiments of the disclosure has been presented for the purposes of illustration and description. It is not intended to be exhaustive or to limit the disclosure to the precise forms disclosed. Many modifications and variations are possible in light of this disclosure. It is intended that the scope of the disclosure be limited not by this detailed description, but rather by the claims appended hereto.

What is claimed is:

1. A Global Positioning System (GPS) or global navigation satellite system (GNSS) comprising at least:
antenna electronics configured to provide signals to a GPS or GNSS receiver, wherein the signals comprise GPS or GNSS satellite signals received from a set of GPS or GNSS satellites and/or one or more falsified signals;
a digital signal processor (DSP) configured to determine, based on an expected location of a respective GPS or GNSS satellite of the set of GPS or GNSS satellites, an expected gain or expected power for a respective signal of the signals; and
the GPS or GNSS receiver, wherein the GPS or GNSS receiver is configured to measure a power of the respective signal,
compare the measured power to the expected gain or expected power, and
determine whether the respective signal is falsified based on the comparison.

2. The GPS or GNSS of claim 1, wherein
to provide the signals comprises to provide a set of antenna beams formed based on the signals,
the expected gain or expected power for the respective signal is based on an expected gain for a respective antenna beam of the set of antenna beams at the expected location of the respective GPS or GNSS satellite,
the respective antenna beam is steered to a respective steering location, and
the measured power of the respective signal comprises a measured power of the respective signal while the respective signal is tracked on the respective antenna beam.

3. The GPS or GNSS of claim 2, wherein the GPS or GNSS receiver is further configured to track the respective signal on the set of antenna beams.

4. The GPS or GNSS of claim 2, wherein
the GPS or GNSS receiver is further configured to
rank the expected gain or expected power relative to a second expected gain or second expected power for a second antenna beam, and
rank the measured power relative to a second measured power for the second antenna beam, and
to compare the measured power to the expected gain or expected power is based on the rankings.

5. The GPS or GNSS of claim 1, wherein to determine whether the respective signal is falsified based on the comparison further comprises to determine whether the respective signal is falsified based on a change over time in one or more of:
the expected location of the respective GPS or GNSS satellite,
an attitude or orientation of a GPS or GNSS antenna array, or
a disparity in expected gain among the signals on an antenna beam.

6. The GPS or GNSS of claim 1, wherein to determine the expected gain or expected power for the respective signal is based on a set of weights.

7. The GPS or GNSS of claim 6,
further comprising adder and/or multiplier circuitry configured to compute a covariance matrix specifying spatial cross-correlations of antenna elements, and
wherein the set of weights is based on
an inverse of the covariance matrix, and
a beam constraint matrix.

8. The GPS or GNSS of claim 1, wherein:
the respective signal is authentic and originates from the respective GPS or GNSS satellite; or
the respective signal is falsified and originates from one or more of a satellite spoofer, an aircraft spoofer, a drone spoofer, a maritime spoofer, or a land based spoofer.

9. A Global Positioning System (GPS) or global navigation satellite system (GNSS) method, comprising:
providing, by antenna electronics and to a GPS or GNSS receiver, signals, wherein the signals comprise GPS or GNSS satellite signals received from a set of GPS or GNSS satellites and/or one or more falsified signals;
determining, by a digital signal processor (DSP) and based on an expected location of a respective GPS or GNSS satellite of the set of GPS or GNSS satellites, an expected gain or expected power for a respective signal of the signals;
measuring, by the GPS or GNSS receiver, a power of the respective signal;
comparing the measured power to the expected gain or expected power; and
determining whether the respective signal is falsified based on the comparison.

10. The GPS or GNSS method of claim 9, wherein
providing the signals comprises forming a set of antenna beams based on the signals,
determining the expected gain or expected power for the respective signal comprises determining an expected gain or expected power for a respective antenna beam of the set of antenna beams at the expected location of the respective GPS or GNSS satellite,
the respective antenna beam is steered to a respective steering location, and
measuring the power for the respective signal comprises measuring the power for the respective signal while the respective signal is tracked on the respective antenna beam.

11. The GPS or GNSS method of claim 10, further comprising tracking, by the GPS or GNSS receiver, the respective signal on the set of antenna beams.

12. The GPS or GNSS method of claim 10,
further comprising
ranking the expected gain or expected power relative to a second expected gain or second expected power for a second antenna beam, and
ranking the measured power relative to a second measured power for the second antenna beam, and
wherein comparing the measured power to the expected gain or expected power is based on the rankings.

13. The GPS or GNSS method of claim 9, wherein determining whether the respective signal is falsified based on the comparison further comprises determining whether the respective signal is falsified based on a change over time in one or more of:
the expected location of the respective GPS or GNSS satellite,
an attitude or orientation of a GPS or GNSS antenna array, or
a disparity in expected gain among the signals on an antenna beam.

14. The GPS or GNSS method of claim 9, wherein determining the expected gain or expected power for the respective signal is based on a set of weights.

15. The GPS or GNSS method of claim 14,
further comprising computing, by adder and/or multiplier circuitry, a covariance matrix specifying spatial cross-correlations of antenna elements, and
wherein the set of weights is based on
an inverse of the covariance matrix, and
a beam constraint matrix.

16. A system, comprising
a Global Positioning System (GPS) or global navigation satellite system (GNSS) antenna array configured to receive signals, wherein the signals comprise GPS or GNSS satellite signals received from a set of GPS or GNSS satellites and/or one or more falsified signals;
antenna electronics configured to provide the signals comprising the GPS or GNSS satellite signals to a GPS or GNSS receiver, and
a GPS or GNSS digital signal processor (DSP) configured to determine, based on an expected location of a respective GPS or GNSS satellite of the set of GPS or GNSS satellites, an expected gain or expected power for a respective signal of the signals; and
the GPS or GNSS receiver, wherein the GPS or GNSS receiver is configured to:
measure a power of the respective signal;
compare the expected gain or expected power to the measured power; and
determine whether the respective signal is falsified based on the comparison.

17. The system of claim 16, wherein
to provide the signals to the receiver further comprises to form a set of antenna beams based on the signals received by the antenna array,
the expected gain or expected power for the respective signal is based on an expected gain for a respective antenna beam of the set of antenna beams at the expected location of the respective GPS or GNSS satellite,
the antenna electronics are further configured to steer the respective antenna beam to a respective steering location, and
the measured power of the respective signal comprises a measured power of the respective signal while the respective signal is tracked on the respective antenna beam.

18. The system of claim 17, wherein
the GPS or GNSS receiver is further configured to
rank the expected gain or expected power relative to a second expected gain or second expected power for a second antenna beam, and
rank the measured power relative to a second measured power for the second antenna beam, and
to compare the measured power to the expected gain or expected power is based on the rankings.

19. The system of claim 16, wherein to determine whether the respective signal is falsified based on the comparison comprises to determine whether the respective signal is falsified based on a change over time in one or more of:
the expected location of the respective GPS or GNSS satellite,
an attitude or orientation of the GPS or GNSS antenna array, or
a disparity in expected gain among the signals on an antenna beam.

20. The system of claim 16, wherein to determine the expected gain or expected power for the respective signal is based on a set of weights.
